(19) United States
(12) Patent Application Publication
(10) Pub. No.: US 2021/0234828 A1
(43) Pub. Date: Jul. 29, 2021

(54) METHOD FOR UPDATING A DATABASE OF A VOICE OVER IP NETWORK

(71) Applicant: ORANGE, Paris (FR)

(72) Inventors: Stephane Fouquet, Chatillon Cedex (FR); Juan Pascual, Chatillon Cedex (FR); Miguel Labranche, Chatillon Cedex (FR)

(21) Appl. No.: 15/734,724

(22) PCT Filed: May 29, 2019
(86) PCT No.: PCT/FR2019/051262

§ 371 Date: Dec. 3, 2020

(30) Foreign Application Priority Data
Jun. 6, 2018 (FR) 1854916

(51) Int. Cl. H04L 29/12; H04L 29/06

(52) U.S. Cl. CPC H04L 61/1529; H04L 61/106; H04L 61/605; H04L 65/1006; H04L 61/6022; H04L 63/0869

(57) ABSTRACT

A method for updating a database of a Voice over IP network by a gateway of a local network allowing access to the VoIP network. The method includes: receiving a message to initiate a VoIP call on the VoIP network coming from a terminal connected to the local network; determining a hardware identifier of the terminal from an IP address on the local network contained in the message; if the identifier is paired in the database with a telephone identity, transferring the message to the VoIP network; otherwise: setting up a VoIP channel between the terminal and a voice server hosted by the access gateway; obtaining by the voice server, via this channel, an authentication code of a user of the terminal; if the code is associated with a telephone identity allocated by the VoIP network, updating the database by pairing the identifier of the terminal with this telephone identity.

### CROSS-REFERENCE TO RELATED APPLICATIONS

This Application is a Section 371 National Stage Application of International Application No. PCT/FR2019/051,262, filed May 29, 2019, the content of which is incorporated herein by reference in its entirety, and published as WO 2019/234325 on Dec. 12, 2019, not in English.

### BACKGROUND OF THE INVENTION

The invention relates to the general field of telecommunications.

It more specifically concerns a method for pairing, at the level of a telephone network, a hardware identifier of a terminal of a user with a telephone identity allocated to the user by the telephone network.

The invention thus has a preferred but nonlimiting application in the context of fixed telephony, and in particular fixed telephony based on Voice over IP (or VoIP) technology.

In the current state of the art, in fixed telephony (by contrast with mobile telephony), the telephone operator allocates to each user a public telephone identity intended to be used over the telephone network, then this public telephone identity is associated (i.e. paired) with a dedicated terminal of the user (for example with a particular telephone). This allows the telephone operator, when a terminal issues a call over its network using a public telephone identity, to check that this terminal is indeed associated with this telephone identity and is indeed authorized to use it. As long as a terminal is not paired in the information system of the telephone operator with a public telephone identity allocated by the operator to a user, the terminal is not capable of making any call whatsoever over the telephone network of the operator by using this identity. For the user of the terminal, this situation can prove somewhat unsettling: no tone is issued in his telephone when he picks it up to issue a call, at the most he is prompted to register his terminal before any prior use over the telephone network.

To pair a terminal with a public telephone identity, the telephone network relies on an identifier of the terminal used to identify it unequivocally. This identifier is typically a hardware identifier of the terminal, such as for example a MAC (Medium Access Control) address used to identify it in a unique manner. At present, access to this hardware identifier by the telephone network operator generally requires the involvement of an administrator and can prove lengthy and tiresome to implement. The effort to be provided is all the more considerable in the current context of VoIP telephony in which one is no longer in the presence of a point-to-point link as in the past for RNIS networks between the access gateway to the telephone network (currently referred to as a “box”) and a terminal, but where different terminals can be used and share one and the same public telephone identity. In this context, the administrator must be involved each time one wishes to attribute the telephone identity of a user to another terminal.

Consequently, there is a need for a method allowing an operator of a Voice over IP telephone network to easily perform the pairing of the telephone identities that it allocates on its network with the hardware identifiers of the terminals able to use these identities to access the network.

### Subject and Summary of the Invention

The invention in particular meets this need by proposing a method for updating a database of a Voice over IP network by a gateway of a local network allowing access to the Voice over IP network, the method comprising:
a step of receiving a message to initiate a Voice over IP call on the Voice over IP network coming from a terminal connected to the local network;
a step of determining a hardware identifier of the terminal from an IP address used by the terminal on the local network and contained in the call initiation message, this hardware identifier uniquely identifying the terminal;
if the hardware identifier is paired in the database of the Voice over IP network with a telephone identity allocated by the Voice over IP network, a step of transferring the call initiation message to the Voice over IP network for setting up the call on the Voice over IP network with a recipient of the call initiation message;
otherwise:
   a step of setting up a Voice over IP channel between the terminal and a voice server hosted by the access gateway;
   a step of obtaining by the voice server, via the channel set up, an authentication code of a user of the terminal;
   if the obtained authentication code is associated at Voice over IP network level with a telephone identity allocated by the Voice over IP network, a step of updating the database by pairing, in the database, the hardware identifier of the terminal with this telephone identity.

Correspondingly, the invention also relates to an access gateway to a voice over IP network, connected to a local network and comprising:
a receiving module, able to receive a message to initiate a Voice over IP call over the Voice over IP network coming from a terminal connected to the local network;
a determining module, configured to determine a hardware identifier of the terminal from an IP address used by the terminal on the local network and contained in the call initiation message;
a transferring module, enabled if the hardware identifier is paired in a database of the Voice over IP network with a telephone identity allocated by the Voice over IP network, and configured to transfer the call initiation message to the Voice over IP network for setting up the call over the Voice over IP network with a recipient of the call initiation message;
modules, otherwise enabled, comprising:
   a setting-up module, configured to set up the Voice over IP call between the terminal and a voice server hosted by the access gateway;
   an obtaining module, configured to obtain via the voice server and the channel set up an authentication code of a user of the terminal;
   an updating module, enabled if the obtained authentication code is associated at Voice over IP network level with a telephone identity allocated by the Voice over IP network, and configured to update the database by pairing, in the database, the hardware identifier of the terminal with this telephone identity.

The invention also offers a simple and automated method for collecting the hardware identifiers of the terminals of the users of a Voice over IP telephone network and pairing them with the telephone identities allocated to these users by the network. The hardware identifiers collected are for example the MAC (Medium Access Control) addresses of the terminals, which uniquely identify them. These hardware identifiers are advantageously collected in accordance with the invention by the access gateways to the Voice over IP network (also commonly referred to as a “box”) to which the terminals are connected. These gateways can for example be supplied to the users of the terminals by the operator of the Voice over IP telephony network. This special case facilitates exchanges between the gateways and the telephone network since they are managed by the same operator. This hypothesis is however not limiting to the invention. It should moreover be noted that it is these gateways that allocate to the terminals their IP addresses for communicating over their local networks, and which, if they do not already keep a table of correspondence between these IP addresses and the hardware identifiers of the terminals to which they are connected, are able to easily identify such hardware identifiers, as further detailed below.

The method proposed by the invention therefore advantageously makes it possible to dispense with the involvement of an administrator and therefore facilitates the updating of the information system of the operator of the telephone network in the event of a user changing terminal.

The invention is consequently particularly suitable in the context of IP telephony wherein the use of multiple terminals associated with one and the same public telephone identity is made possible and routine. It is also particularly advantageous in dynamic environments where terminals are often replaced or new terminals are liable to be added (e.g. extension of the stock of terminals of a company, etc.).

Moreover, the method proposed by the invention to provide the information system of the telephone network is very simple to implement and secure: it only requires the telephone network side to supply (and store) an authentication code of the user, associated with the telephone identity allocated to it by the telephone network, an authentication code that the user is prompted to supply to a voice server the first time he accesses the telephone network with his terminal to allow, where applicable, the pairing of his terminal with its telephone identity. The method according to the invention therefore requires no modification of the terminal in the strict sense of the term (it can be used with any terminal able to initiate a call over a Voice over IP network), and improves the experience of the user who is redirected upon this first access to a voice server. In other words, unlike the state of the art, the user can initiate a call from his terminal even if the latter is not yet paired with the telephone identity allocated to the user (i.e. he does not encounter an absence of tone in its terminal when he wants to issue such a call), but instead of transmitting this call tow the Voice over IP network so that it can be set up with its recipient, this call is automatically redirected by the gateway to a voice server that prompts the user to supply an authentication code to perform the pairing.

The authentication code supplied by the user allows the gateway according to the invention to make sure that the hardware identifier that it is itself able to retrieve from the IP address included in the call initiation message issued by the terminal, and therefore that the terminal itself uniquely identified by this hardware identifier, does indeed correspond to a user authorized to access the telephone network, and that the information that it provides to the information system of the telephone network are correct.

Furthermore, advantageously, the authentication code is only required from the user a single time for each of its terminals, i.e. only the first time he attempts to use the Voice over IP network with these terminals to initiate Voice over IP calls. For the following calls, the gateway is advantageously configured to detect that the pairing has already been made at the telephone network and directly transfer the call initiation message to the telephone network for setting up the call with its recipient.

The invention can therefore apply to many contexts, domestic or professional: the terminal within the meaning of the invention can be any device implementing Voice over IP technology such as a hardware or software telephone (or “softphone”), but also a private automatic branch exchange (or IPBX for IP Private Branch exchange) to which are attached a plurality of Voice over IP terminals and allowing, for example, a company to manage its phone calls, both internal and external, using the IP protocol. A user within the meaning of the invention can therefore be a private individual or a group of users such as a company to which the operator of the telephone network has allocated a telephone identity for communicating over its network.

In a particular embodiment, the method according to the invention comprises, before the step of updating the database, if the authentication code supplied is associated at Voice over IP network level with a telephone identity allocated by the Voice over IP network, a step of receiving this telephone identity coming from the Voice over IP network.

This embodiment makes it possible to improve the safety of the updating method according to the invention, the telephone identity being directly transmitted to the gateway by the Voice over IP network having allocated it to the user and corresponding to the authentication code supplied by the user.

In another embodiment, the telephone identity allocated by the Voice over IP network and used during the updating step is supplied to the voice server by the user during the step of obtaining the authentication code.

In this case, a double check can be made at Voice over IP network level before updating the database: a first check can consist in making sure that the authentication code supplied does indeed correspond to a telephone identity allocated to a user by the Voice over IP network, whereas a second check can consist in checking that the telephone identity supplied in association with the authentication code is indeed consistent with the telephone identity associated with this code at telephone network level.

In a particular embodiment, the method comprises, following the updating step, a step of transferring the initiation message to the Voice over IP network for setting up the call with a recipient of the call initiation message.

This embodiment makes it possible to facilitate the experience of the user who has no need to re-issue a call following the pairing of his terminal.

In a variant, the method comprises, following the updating step, a step of prompting the user by the voice server to re-issue his call initiation message over the Voice over IP network. In accordance with the invention, as the terminal is now paired with the telephone identity of the user at Voice over IP network level, the new call initiation message issued is directly transferred by the gateway to the Voice over IP network for setting up the call with the recipient of the call initiation message.

As mentioned on several occasions, the invention is applicable in the context of a Voice over IP telephone network.

In a preferred embodiment, this Voice over IP telephone network implements the SIP (Session Initiation Protocol), and the call initiation message sent by the terminal is in accordance with the SIP protocol (in particular it is a SIP INVITE message well-known per se). The SIP protocol is a protocol currently used in Voice over IP networks, which facilitates the implementation of the invention in different networks.

Of course, other protocols can be used in a variant, such as for example proprietary protocols.

In a particular embodiment, the voice server comprises a voice synthesis module, and/or a voice recognition module, and/or a conversational agent.

Such modules allow the voice server to easily retrieve the authentication code to perform the pairing of the terminal. This embodiment moreover improves the interactivity with the user who can interact with the voice server in a more user-friendly manner.

In another embodiment, the method comprises:
a step of receiving an unpairing command coming from the terminal; and
a step of deleting the hardware identifier of the terminal in the database.

This makes it possible to manage the situation in which a user changes terminal for example, and typically no longer plans to use the terminal that is paired to its public identity.

In a particular embodiment, the different steps of the updating method and/or communication method are determined by instructions of computer programs.

Consequently, the invention also concerns a computer program on an information medium, this program being able to be implemented in a gateway or more generally on a computer, this program including instructions suitable for implementing the steps of an updating method as described above.

The invention also concerns a computer program on an information medium, this program being able to be implemented on a terminal or more generally on a computer, this program including instructions suitable for implementing the steps of a communication method as described above.

This program can use any programming language, and be in the form of source code, object code, or intermediate code between source code and object code, such as in a partially compiled form, or in any other desirable form.

The invention also concerns an information or recording medium readable by a computer and including instructions of a computer program as mentioned above.

The information or recording medium can be any entity or device capable of storing the program. For example, the medium can include a storage means, such as a ROM, for example a CD-ROM or a microelectronic circuit ROM, or else a magnetic recording means, for example a diskette (floppy disk) or a hard disk.

Moreover, the information or recording medium can be a transmissible medium such as an electrical or optical signal, which can be routed via an electrical or optical cable, by radio or by other means. The program according to the invention can in particular be downloaded over a network of Internet type.

Alternatively, the information or recording medium can be an integrated circuit wherein the program is incorporated, the circuit being suitable for executing or for being used in the execution of the method in question.

According to another aspect the invention also concerns a communication system comprising:
at least one terminal of a user connected to a local network;
a database of a Voice over IP network; and
an access gateway to the Voice over IP network in accordance with the invention and connected to the local network, this access gateway being able to update the database of the Voice over IP network with a telephone identity allocated by the Voice over IP network to the user of the terminal paired with a hardware identifier of the terminal of the user.

It is also possible to envisage, in other embodiments, that the updating method, the gateway and the communication system according to the invention have in combination all or part of the aforementioned features.

### BRIEF DESCRIPTION OF THE DRAWINGS

Other features and advantages of the present invention will become apparent from the description given below, with reference to the appended drawings which illustrate an exemplary embodiment thereof devoid of any limitation. In the figures:

FIG. 1 schematically represents a communication system in accordance with the invention in a particular embodiment;

FIG. 2 illustrates an example of hardware architecture of an access gateway of the communication system of FIG. 1, in accordance with the invention; and

FIG. 3 represents, in the form of a flow diagram, the main steps of an updating method as implemented in a particular embodiment by the gateway of FIG. 2.

### DETAILED DESCRIPTION OF THE INVENTION

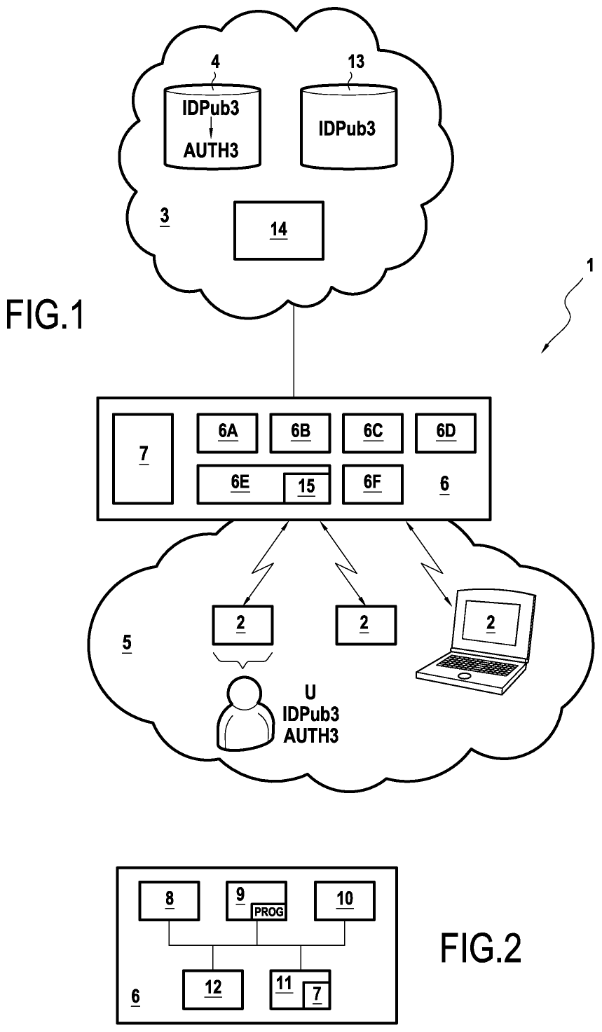

FIG. 1 shows, in its environment, a communication system 1 in accordance with the invention, in a particular embodiment.

In the example illustrated in FIG. 1, the communication system 1 makes it possible to simplify the collection of the hardware identifier of a terminal 2 of a user U by a Voice over IP telephony network 3 to which the user U has taken out a subscription. Here we are interested in a fixed telephone network implementing Voice over IP technology based on the SIP (Session Initiation Protocol). This latter hypothesis is however not limiting in itself, and the invention can be applied to other protocols suitable for Voice over IP, such as for example to proprietary protocols.

When the user takes out his subscription to the operator of the network 3, a public telephone identity IDPub3 is supplied by the operator of the network 3 to the user U. This telephone identity identifies the user U on the Voice over IP network 3 and allows him to communicate via this network with other users. It is for example a telephone number, an address of SIP URI (Uniform Resource Identifier) type, an address of URL (Uniform Resource Locator) type, etc.

In accordance with the invention, the operator of the network 3 supplies to the user U, for example when he takes out the aforementioned subscription, an authentication code AUTH3 associated in a database 4 of the network 3 with the public telephone identity IDPub3. No limitation is attached to the form that this authentication code takes, or how it is generated or exchanged between the network 3 and the user U (though preferably securely): it can for example be a string of alphanumeric characters or only numeric characters, a login/password pair agreed with the user U, etc.; this code can be supplied by mail, by electronic message, by SMS (Short Message Service) or by any other means to the user U.

In the example envisioned in FIG. 1, we consider a residential context, wherein one or more users U possess one or more terminals 2, connected to a local network 5 managed by a residential gateway or box 6, in accordance with the invention. For the sake of simplification, it is supposed here that each of the terminals 2 is capable of implementing a Voice over IP (VoIP) communication technique. However, this hypothesis is in no way limiting. Moreover, no limitation is attached to the nature of the terminals: they can be telephones, hardware or software, computers equipped with Voice over IP software, etc. It is supposed here that the terminals 2 are equipped with input/output means allowing them to interact with the user U such as for example a keyboard, a microphone and a loudspeaker etc.

The gateway 6 allows the terminals 2 to access networks external to the local network 5, such as for example the public Internet network or else the Voice over IP fixed telephone network 3. In other words, to issue a call over the network 3 or to receive a call via this network 3, the terminals 2 go through the gateway 6.

The functionality of such a gateway is known per se and is not described in detail here. It is for example the gateway 6 that allows the terminals 2 to access these networks external to the local network 5, such as for example the public Internet network or else the fixed Voice over IP telephone network. In other words, to issue a call over the network 3 or receive a call via this network 3, the terminals 2 go through the gateway 6.

The functionality of such a gateway are known per se and is not described in detail here. It is for example the gateway 6 that attributes to each of the terminals 2 a separate IP address for communicating over the local network 5. With each attribution of an IP address denoted @IP2, to a terminal 2, the gateway 6 obtains from this terminal a hardware identifier uniquely identifying it, namely here its MAC address, denoted @MAC2. For this purpose, the gateway 6 can issue a request according to for example the ARP (Address Resolution Protocol) over the local network 5 using as parameter the IP address @IP2 allocated to the terminal 2. Such a request is known to those skilled in the art. Once the MAC address of the terminal 2 is obtained, this is stored by the gateway 6 in a so called “ARP” table 7 in correspondence with the IP address @IP2 allocated to the terminal 2. This table ARP 7 is kept updated by the gateway 6, each time a new IP address is attributed to a terminal in the local network 5.

In the embodiment here, the gateway 6 has the hardware architecture of a computer, as shown in FIG. 2. It particularly comprises a processor 8, a read-only memory 9, a random-access memory 10, a non-volatile memory 11 (wherein is notably stored, here, the ARP table 7), and communication means 12. These communication means 12 allow the gateway 6 to communicate with the terminals 2 of the local network 5 (via wired or wireless connectivity), but also with items of equipment belonging to the remote networks, such as for example with the Voice over IP telephone network. 3. They particularly include here a network card and a VoIP protocol stack suitable for implementing a Voice over IP communication technique according to the SIP protocol.

The read-only memory 9 of the gateway 6 constitutes a recording medium in accordance with the invention, readable by the processor and on which is recorded a computer program PROG in accordance with the invention, including instructions for executing an updating method according to the invention. This method is intended, in accordance with the invention, to update (i.e. to provide) a database 13 of the Voice over IP network 3 wherein is stored, in association with each public telephone identity allocated by the network 3 to a user, a hardware identifier of a terminal that the user in question uses to make his calls on the network 3. The hardware identifiers which are paired in the database 13 with the public telephone identities allocated by the network 3 uniquely identify the terminals to which they relate. In the embodiment described here, these hardware identifiers are MAC addresses, as previously discussed. Moreover, it is supposed here that when the operator of the network 3 allocates a public telephone identity to a user, it enters this telephone identity into the database 13. Consequently, when the user U has taken out his subscription to the operator of the network 3, the operator has added to the database 13 the telephone identity IDPub3 that it has allocated to the user U. however, at this stage, no hardware identifier is paired with this telephone identity.

The program PROG defines various functional and software modules of the gateway 6 able to implement the steps of the updating method according to the invention of the database 13 and relying on the hardware elements 8-12 of the gateway 6. These modules here particularly comprise: a receiving module 6A, able to receive a message to initiate a Voice over IP call over the Voice over IP network 3 coming from a terminal 2 of a user U connected to the local network 5. Such a message is, in the example envisioned here of a Voice over IP telephone network implementing the SIP protocol, a SIP INVITE message comprising in the TO field of its header the recipient of the Voice over IP call;
a determining module 6B, configured to determine a hardware identifier of the terminal 2 (in the example envisioned here its MAC address @MAC2) which originated the SIP INVITE message received by the receiving module 6A on the basis of the IP address used by the terminal 2 on the local network 5 and contained in the SIP INVITE message;
a transferring module 6C, enabled if the hardware identifier (@MAC2 here) determined by the determining module 6B is paired in the database 13 of the Voice over IP network 3 with a telephone identity allocated by the network 3 to a user, and configured to transfer the SIP INVITE initiation message received by the receiving module 6A to the network 3 for setting up the call with the recipient of this call (for example to a Voice over IP platform 14 of the network 3 able to manage this call for the purpose of setting it up);
modules 6D-6F, otherwise enabled, and comprising:
   a setting-up module 6D, configured to set up a Voice over IP channel between the terminal 2 and an interactive voice server 15 hosted by the gateway 6. In the embodiment described here, the interactive voice server 15 comprises a voice recognition module (not shown) known per se, allowing it to interact with the user U. In a variant, the interactive voice server 15 can comprise a conversational agent and/or a voice synthesis module, also known per se and not described in detail here;
   an obtaining module 6E, configured to obtain from the user U of the terminal 2 via the voice server 15, and more specifically the Voice over IP channel set up between the terminal and the interactive voice server 15, an authentication code of this user, namely the authentication code AUTH3 which here has been supplied to it by the network 3 when the user took out a subscription to be able to communicate over the network 3 using the telephone identity IDPub3. Note that the user U can supply this authentication code in different ways, for example vocally or by inputting the authentication code on the keyboard of his terminal, in which case the authentication code thus inputted is then transmitted by the terminal in the Voice over IP channel using vocal frequencies or DTMF (Dual Tone Multi Frequency). The module 6E following the chosen implementation can therefore comprise the aforementioned voice recognition module of the interactive voice server 15, and/or a module for receiving DTMF signals also contained here in the interactive voice server 15, and able to extract from the DTMF signal received from the terminal the authentication code conveyed by this signal;
   an updating module 6F, enabled if the authentication code supplied by the user U via the voice server 15 is associated at Voice over IP network 3 level (in its database 4 here) with a telephone identity allocated by the Voice over IP network 3, and configured to update the database 13 by pairing therein the hardware identifier of the terminal 2 with this telephone identity. Note that in the database 13, one and the same telephone identity can be paired with several hardware identifiers of different terminals.

The functions of the modules 6A-6F are now described with reference to the steps of the updating method according to the invention.

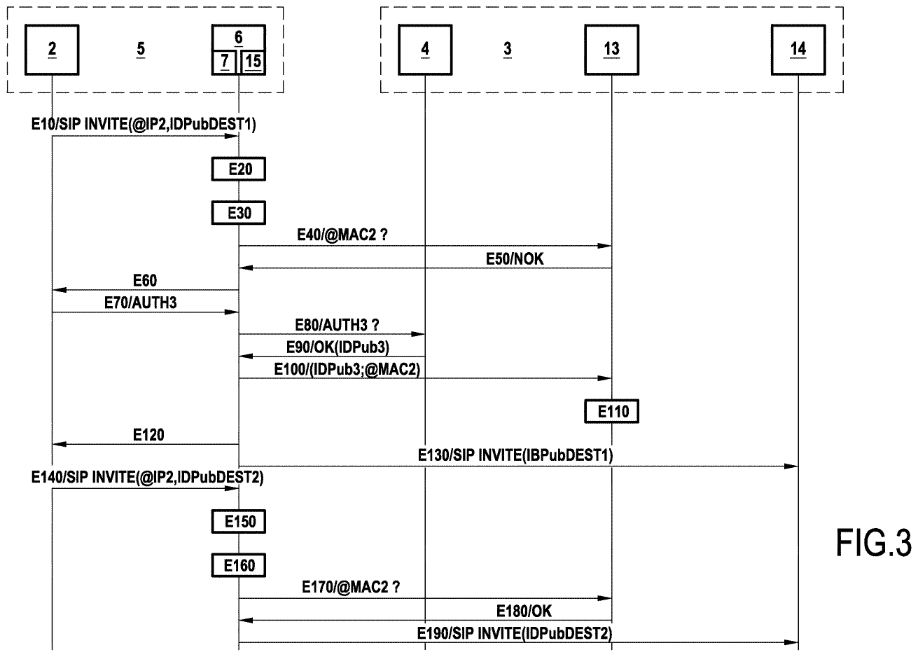

FIG. 3 shows the main steps of the updating method according to the invention, as updated in a particular embodiment by the gateway 6.

It is supposed here that the user U wishes to use one of his terminals 2 to make a Voice over IP call over the fixed telephone network 3 and that this terminal 2 (and not, here, any other terminal of the user U) has until now never been paired with the telephone identity IDPub3 received by the user U when he took out his subscription to the operator of the network 3. In other words, in the example envisioned here, the database 13 kept by the network 3 contains no terminal hardware identifier paired with the telephone identity IDPub3.

This hypothesis is however not limiting: in an alternative hypothesis it could be envisioned that the telephone identity IDPub3 is paired in the database with one or more hardware identifiers of terminals separate from the terminal 2. To issue a call over the network 3, the terminal 2 sends a SIP INVITE message addressed to the network 3 containing, in its header (in the TO field), the telephone identity of the recipient DEST1 that the user U is seeking to connect with, denoted IDPubDEST1 here (step E10). The SIP INVITE message also contains in its header, in the FROM field, its IP address @IP2 on the local network 5. The SIP INVITE message issued by the terminal 2 transits via the gateway 6 and is received by its receiving 6A module (step E20).

The determining module 6B of the gateway 6 extracts the address @IP2 contained in the SIP INVITE message and polls the ARP table 7 kept by the gateway 6 with this address @IP2 to determine a hardware identifier of the terminal 2. It obtains in response the MAC address @MAC2 of the terminal 2 (step E30).

In a variant, if the gateway 6 does not keep such an ARP table updated, the determining module 6B can poll the terminal 2 after receiving the SIP message by sending it a request in accordance with the ARP protocol comprising as a parameter the IP address @IP2 of the terminal 2, a request to which the terminal 2 replies by transmitting its MAC address @MAC2.

Then the gateway 6, here via its determining module 6B, polls the network 3 and more specifically its database 13 to determine whether or not the hardware identifier @MAC2 of the terminal 2 is paired in this database with a telephone identity allocated by the network 3 to a user (step E40).

In the example envisioned here, the hardware identifier @MAC2 is not paired with any telephone identity on the network 3 in the database 13.

Consequently, the determining module 6B receives a negative reply from the database 13 of the network 3 (step E50). This negative reply triggers the enabling of modules 6D to 6F of the gateway 6.

More precisely, the gateway 6, via its module 6D, then triggers the setting up of a Voice over IP channel between the terminal 2 and the interactive voice server 15 via the local network 5, in a manner known per se (step E60). More specifically for this purpose, in the embodiment described here and the SIP context envisioned, the module 6D sends to the interactive voice server 15 a message SIP INVITE message to which the latter replies with a 200 OK message containing its media information for setting up a media stream (RTP stream for Real Time Protocol). The module 6D responds to the SIP INVITE message issued by the terminal 2 by sending it a 200 OK acceptance message containing the media information of the voice server 15.

On receiving this reply message, a Voice over IP channel is set up between the terminal 2 and the voice server 15 (note that the signaling relating to this Voice over IP channel is not exchanged directly between the terminal 2 and the voice server 15 but goes through the gateway 6, the signaling and the media streams being managed separately in the SIP protocol).

Once this call has been set up, the interactive voice server 15 interacts with the user U, and particularly prompts him to supply the authentication code that he has received from the network 3 in association with his telephone identity on taking out his subscription to the operator of the network 3.

In reply to this prompt, the user U supplies via his terminal 2 the authentication code AUTH3 that the operator of the network 3 gave him when he took out his subscription (step E70). For this purpose, he can either pronounce the authentication code AUTH3 via the microphone of his terminal 2, or more discreetly, supply this authentication code via the keyboard of his terminal 2. In the latter hypothesis, the authentication code is then transmitted over the Voice over IP channel via a signal using vocal frequencies (DTMF) and is received by the receiving module of the interactive voice server 15.

The authentication code AUTH3 is recognized by the interactive voice server 15 by way of its voice recognition module or by way of its DTMF signal receiving module (as a reminder, included here in the module 6E for obtaining the gateway 6) (step E80). Note that the prompting of the user U to supply his authentication code and the obtaining of the code constitute a step of obtaining the authentication code of the user U within the meaning of the invention.

Then the gateway 6, here by way of its determining module 6B, checks with the network 3 whether or not the authentication code AUTH3 supplied by the user U corresponds to a telephone identity previously allocated by the network 3 to a user. For this purpose, the determining module here 6B polls the database 4 of the network 3 by transmitting to it the authentication code AUTH3 received from the user U via the interactive voice server (step E80).

In the example envisioned here, the authentication code AUTH3 is associated in the database 4 with a telephone identity, namely the telephone identity IDPub3 allocated by the network 3 to the user U. The database 4 returns a positive answer to the gateway 6 including the telephone identity IDPub3 (step E90).

On receiving the positive answer from the database 4 and the public telephone identity IDPub3, the gateway 6 via its updating module 6F updates the database 13 of the network (step E100). For this purpose, the updating module 6F sends an updating message to the database 13 comprising the public telephone identity IDPub3 of the user U paired with the MAC address @MAC2 of his terminal 2.

On receiving this message, the database 13 is updated with the address @MAC2 of the terminal 2 (step E110): after this update, the address @MAC2 is paired in the database with the public telephone identity @IDPub3. In the embodiment described here, the gateway 6, after this update, ends the call set up between the terminal 2 and the interactive voice server 15 (step E120), and transfers the call initiation SIP INVITE message received in step E10 to the network 3 (and more specifically to its VoIP platform 14) for setting up the call on the Voice over IP network 3 with the recipient corresponding to the public identity IDPubDEST1 (step E130).

In another embodiment, the gateway 6, before ending the call set up between the terminal 2 and the interactive voice server 15, prompts the user U, via the interactive voice server 15, to reissue his call addressed to the network 3.

Note that in the embodiment described here, the public identity IDPub3 that the gateway 6 pairs with the hardware identifier of the terminal 2 is transmitted by the Voice over IP network. In another embodiment, this public identity can be supplied by the user at the time of his interaction with the interactive voice server, for example when the user supplies his authentication code AUTH3. The public identity can then be transmitted by the gateway 6 to the database 4 to make an additional check, namely that in the database this public identity is indeed associated with the authentication code supplied by the user.

It is now supposed that the user U wishes to issue a new call via his terminal 2, for example to another recipient, the telephone identity of which is IDPubDEST2.

The terminal 2 sends a SIP INVITE message addressed to the network 3 containing in the TO field of its header the public telephone identity IDPubDEST2 and, in its FROM field, the IP address of the terminal 2 @IP2 (step E140).

The SIP INVITE message issued by the terminal 2 transits via the gateway 6 and is received by its receiving module (step E150).

As previously described in step E30, the determining module 6B of the gateway 6 extracts the address @IP2 contained in the SIP INVITE message and polls the ARP table 7 kept by the gateway 6 with this address @IP2 to determine a hardware identifier of the terminal 2. It obtains in reply the MAC address @MAC2 of the terminal 2 (step E160).

In a variant, if the gateway 6 does not keep such an ARP table updated, the determining module 6B can poll the terminal 2 by sending it a request in accordance with the ARP protocol as described previously.

Then the gateway 6, here via its determining module 6B, polls the network 3 and more specifically its database 13 to determine whether or not the hardware identifier @MAC2 of the terminal 2 is paired in this database with a telephone identity allocated by the network 3 to a user (step E170). Following the updating step E100, the hardware identifier @MAC2 is paired in the database 13 with the telephone identity IDPub3. The database 13 therefore gives the determining module 6B a positive answer (step E180). This positive answer triggers the enabling of the transferring module 6C of the gateway 6, which transfers the SIP INVITE message received in step E150 to the network 3 (and more specifically to the VoIP platform 14) for setting up the call (step E190). The way in which the call is set up is known per se, and not described here.

In the embodiment described here, the user of the terminal 2 is given the possibility of unpairing this terminal 2 from the public identity IDPub3, for example since it no longer uses this terminal. For this purpose, a dedicated technical number can be supplied to the user, for example 1234 that the latter can compose via its terminal 2 by sending a SIP INVITE message addressed to the number 1234. This SIP INVITE message transits via the gateway 6 as mentioned previously which, on detection of the dedicated technical number 1234 to which the SIP INVITE is addressed, interprets this SIP INVITE message as a command to delete the pairing of the terminal 2 stored in the database 13.

In response to this message it therefore deletes from the database 13 the pairing of the hardware identifier @MAC2 with the public identity IDPub3. Note that if other hardware identifiers are associated in the database 13 with the public identity IDPub3, this deletion has no effect on these identifiers.

The example envisioned here concerns the pairing of a terminal 2 of a user when the terminal is directly connected to the gateway. This can be the case for example in a domestic or residential environment. The invention can however be applied to other contexts: typically, the user can be a legal entity, such as a company, and the terminal paired with the public identity can be a platform of IPBX type in charge of connecting a plurality of company users (e.g. employees) to a Voice over IP network via an access gateway 6 to the Voice over IP network. In this case, it is the hardware identifier of the IPBX platform which is paired in the Voice over IP network with the public identity (i.e. the terminal within the meaning of the invention is an IPBX platform). Many other contexts can also be envisioned.

Although the present disclosure has been described with reference to one or more examples, workers skilled in the art will recognize that changes may be made in form and detail without departing from the scope of the disclosure and/or the appended claims.

1. An updating method for updating a database of a Voice over IP network by an access gateway of a local network allowing access to the Voice over IP network, the method comprising:
receiving a call initiation message to initiate a Voice over IP call on the Voice over IP network coming from a terminal connected to the local network;
determining a hardware identifier of the terminal from an IP address used by the terminal on the local network and contained in the call initiation message, said hardware identifier uniquely identifying the terminal;
if the hardware identifier is paired in the database of the Voice over IP network with a telephone identity allocated by the Voice over IP network, transferring the call initiation message to the Voice over IP network for setting up the call on the Voice over IP network with a recipient of the call initiation message;
otherwise;
setting up a Voice over IP channel between the terminal and a voice server hosted by the access gateway;
obtaining by the voice server, via the channel set up, an authentication code of a user of the terminal;
in response to the obtained authentication code being associated at Voice over IP network level with a telephone identity allocated by the Voice over IP network, updating the database by pairing, in the database, the hardware identifier of the terminal with this telephone identity.

2. The updating method as claimed in claim 1 wherein the hardware identifier of the terminal is determined by issuing over the local network a request according to an ARP (Address Resolution Protocol) using as parameter the IP address of the terminal.

3. The updating method as claimed in claim 1 comprising before the updating of the database, if the authentication code supplied is associated at Voice over IP network level with a telephone identity allocated by the Voice over IP network, receiving this telephone identity coming from the Voice over IP network.

4. The updating method as claimed in claim 1 wherein the telephone identity allocated by the Voice over IP network and used during the updating supplied to the voice server by the user during obtaining of the authentication code.

5. The updating method as claimed in claim 1 comprising, following the updating, transferring the initiation message to the Voice over IP network for setting up the call over the Voice over IP network with a recipient of the call initiation message.

6. The updating method as claimed in claim 1, comprising, following the updating, prompting the user by the voice server to re-issue the call initiation message over the Voice over IP network.

7. The updating method as claimed in claim 1 wherein the call initiation message is a message in accordance with a SIP (Session Initiation Protocol).

8. The updating method as claimed in claim 1 wherein the hardware identifier of the terminal is a MAC (Medium Access Control) address of the terminal.

9. The updating method as claimed in claim 1 comprising:
receiving an unpairing command coming from the terminal; and
deleting the hardware identifier of the terminal in the database.

10. (canceled)

11. A non-transitory computer-readable recording medium on which is recorded a computer program including instructions for executing an updating method for updating a database of a Voice over IP network by an access gateway of a local network allowing access to the Voice over IP network, when the instructions are executed by a processor of the access gateway, wherein the instructions configure the access gateway to:
receive a call initiation message to initiate a Voice over IP call on the Voice over IP network coming from a terminal connected to the local network;
determine a hardware identifier of the terminal from an IP address used by the terminal on the local network and contained in the call initiation message, said hardware identifier uniquely identifying the terminal;
if the hardware identifier is paired in the database of the Voice over IP network with a telephone identity allocated by the Voice over Ip network, transfer the call initiation message to the Voice over Ip network for setting up the call on the Voice over IP network with a recipient of the call initiation message;
otherwise:
set up a Voice over IP channel between the terminal and a voice server hosted by the access gateway;
obtain by the voice server, via the channel set up, an authorization code of a user of the terminal;
in response to the obtained authentication code being associated at Voice over IP network level with a telephone identity allocated by the Voice over IP network, update the database by pairing, the in the database, the hardware identifier of the terminal with this telephone identity.

12. An access gateway a voice over IP network, connected to a local network and comprising:
a processor;
a non-transitory computer-readable medium comprising instructions stored thereon which
when executed by the processor configure the access gateway to;
receive a message to initiate a Voice over IP call over the Voice over IP network coming from a terminal connected to the local network;
determine a hardware identifier of the terminal from an IP address used by the terminal on the local network and contained in the call initiation message, this hardware identifier uniquely identifying the terminal;
if the hardware identifier is paired in a database of the Voice over IP network with a telephone identity allocated by the Voice over IP network, transfer the call initiation message to the Voice over IP network for setting up the call over the Voice over IP network with a recipient of the call initiation message;
otherwise:
set up a Voice over IP call between the terminal and a voice server hosted by the access gateway;
obtain via the voice server and the channel set up an authentication code of a user of the terminal;
the obtained authentication code being associated at Voice over IP network level with a telephone identity allocated by the Voice over IP network, update the database by pairing, in the database, the hardware identifier of the terminal with this telephone identity.

13. The access gateway as claimed in claim 12 wherein the voice server comprises a voice synthesis module, and/or a voice recognition module, and/or a conversational agent.

14. (canceled)
